(19) United States
(12) Patent Application Publication
(10) Pub. No.: US 2010/0263622 A1
(43) Pub. Date: Oct. 21, 2010

(54) ROTARY ENGINE

(76) Inventor: JUNG-KUANG CHOU, TAIPEI HSIEN (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/827,121

(22) Filed: Jun. 30, 2010

Related U.S. Application Data
(63) Continuation-in-part of application No. 12/382,585, filed on Mar. 19, 2009.
Application No. 12/382,585 is a continuation-in-part of application No. 11/649,308, filed on Jan. 4, 2007, now abandoned.
Application No. 11/649,308 is a continuation-in-part of application No. 11/114,059, filed on Apr. 26, 2005, now abandoned.
Application No. 11/114,059 is a continuation-in-part of application No. 10/900,192, filed on Jul. 28, 2004, now abandoned.
Application No. 10/900,192 is a continuation-in-part of application No. 10/392,859, filed on Mar. 21, 2003, now abandoned.

(30) Foreign Application Priority Data
Jan. 23, 2009 (TW) 098102709
Jan. 8, 2010 (TW) 099100322

(51) Int. Cl. F02B 53/00

(52) U.S. Cl. 123/200

(57) ABSTRACT

A rotary engine includes one or more combustion chambers around a turbine, and a movable plate at an opening of the combustion chamber and rotated 90 degrees and protruded from the turbine. Both sides of the movable plate and the diameter of the turbine form an align straight line. The turbine comprises a slide member, a U-shape groove, a ditch with an open end coupled to the movable plate to form the explosion chamber. During explosion, the movable plate drives the turbine to rotate while eliminating the waste gases. The air current and pressure of the explosion apply forces to rotate the bottom of the combustion chamber. The volume of the explosion chamber can be extended to provide a relatively large open space since the movable plate can be moved and a higher pressure gases will be reduced rapidly so that the high-pressure gases can produce a greater force.

### CROSS-REFERENCE TO RELATED APPLICATIONS

This application is a continuation-in part of U.S. patent application Ser. No. 12/382,585 filed on Mar. 19, 2009, which is a continuation-in-part of U.S. patent application Ser. No. 11/649,308 filed on 4 Jan. 2007, which is a continuation-in-part of U.S. application Ser. No. 11/114,059 filed on 26 Apr. 2005, which is a CIP of U.S. application Ser. No. 10/900,192 filed on 28 Jul. 2004 being a continuation-in-part of U.S. application Ser. No. 10/392,859 filed on 21 Mar. 2003, which had claimed priority on Taiwanese application filed on 3 Apr. 2002.

### BACKGROUND OF THE INVENTION

1. Field of the Invention

The present invention relates to a prime mover technology applied to automobiles, airplanes, ships, generators or motors, and more particularly to a rotary engine that adopts a turbine and a slide member installed concentrically with each other and processes a gas through four synchronous processes, respectively: intake, combustion, explosion and exhaust to drive the turbine to rotate by a driving force produced by an expanded space after the explosion takes place

2. Description of the Related Art

According to the operating principle of a traditional engine, high-pressure gases in a cylinder are expanded to push a piston and change the volume of the cylinder to achieve the effect of rotating the engine. However, an explosion chamber of a rotary engine is fixed, so that even if the turbine is rotated, the space of the explosion chamber cannot be expanded. As a result, a direct impact force of air flow can be obtained from the explosion only, but the driving force produced by the expansion of the high-pressure gases cannot be absorbed indirectly, because the space cannot be expanded further. Similarly, a pure dynamic high-pressure gas cannot be expanded to produce a stroke or a driving force in a fixed enclosed volume, and an action exerted onto an internal wall of the explosion chamber is a stress which will offset the impact force of the high-pressure air flow. The aforementioned technical issue of the rotary engine is still a problem awaiting feasible solutions. The problem may be overcome by using a cylinder similar as the traditional one that requires a moving piston to expand the volume in order to reduce the pressure in the cylinder. If the high-pressure gas is expanded naturally to push the piston, it implies that there is a driving force produced at the same time. Using a moving plate to replace the traditional piston is the only way to achieve the foregoing effect. The main characteristics of the rotary engine separate a compression stroke from the traditional engine to provide a smoother operation, an increased number of explosions for reducing the capacity of explosions and the measurement of vibrations, reduced weight and volume, a high-temperature, an instantaneous detonation, a simplified structure, a lower airtight requirement and a fire extinguish resistance. The most different part between the present invention and prior art is described below. The traditional engine is limited with a clearance below 0.05 mm between the cylinder and the piston of a traditional engine. To prevent a thermal expansion and a spontaneous ignition point of 300° C. of petroleum, a continuous water cooling process is required and an intermittent combustion is resulted, and such combustion is taken place at a low temperature in the traditional engine, but the rotary engine adopts an jet cylinder for injecting fuel with a high ignition point into a combustion chamber for combusting the fuel, and air is passed through a thermal exchanger from a discharge end for recycling waste heat. The explosion chamber may reach a temperature of over 600° C. for the continuous combustion, and such combustion is taken place at a high temperature. According to the law of thermodynamics, the temperature of the gases will rise up to 273° C., and the pressure of the gases per unit volume is doubled, after the explosion occurs. In other words, the horsepower will be doubled, and the fuel consumption is halved. In addition, the high-pressure gases produced by the explosion chamber is sprayed into the thermal exchanger through a mist sprayer for absorbing the waste heat, and the mist absorbs heat to become water vapor provided for another set of slide members to drive the turbine to rotate (which is not illustrated in the figure). This engine is not restricted by temperature which facilitates the recycle and reuse of the waste heat, and that is exactly the objective of the present invention. A related prior art, wherein the waste gases produced in the explosion chamber is exhausted through a longer opening of the combustion chamber and a shorter flange at an end of the slide member. However, such prior art has a drawback of unable to remove the waste gas completely, and remaining a portion of the waste gases behind. Although the prior art can improve the pressure to increase the reaction speed and the explosion power, yet the involved composition includes carbon dioxide and water vapor, and both of them are extinguish materials which will be extinguished easily or combusted incompletely to produce poisonous carbon monoxide. In addition, the pressure of the waste gases also has the effects of slowing down or offsetting the impact force for the next explosion and reducing the pressure difference. Though the explosion sound is loud, but the torque is weak.

Therefore, another invention was filed for patent application, wherein a portion of the combustion chamber is clear without mixed gases, in order to provide sufficient expansion space after the explosion takes place, and further provides a greater explosion power for pushing the air flow at a later stage. Experiments and tests show that the explosion sound detected is very loud, but the effect is not confirmed yet.

At present, the most extensively used four-stroke reciprocating piston engine is described as follows. Firstly, a dilute fuel gas is sucked into a cylinder, and such process is called an intake stroke, and then a force is applied to compress the volume into one-eight, and such process is called a compression stroke. Now, the temperature rises, and the distance between fuel molecules becomes shorter, such that when the fuel is ignited, an explosion takes place to push a piston to rotate the engine, and such process is called an explosion stroke. Finally, a force is applied to discharge the waste gases, and such process is called an exhausting stroke. In the aforementioned ignition method, a point is ignited, and then the ignition is extended to a line and a plane, and the low-temperature combustion speed is slow, and there will be a delay of time, so that it is necessary to ignite before the piston reaches the stop point, in order to produce a larger driving force. If the ignition is too early, a high pressure will be produced, such that the rotation cannot reach the stop point and a reverse rotation results. If the ignition is too late, a low pressure will be produced, such that the rotation power is not enough. Therefore, it is necessary to control the ignition timing. Further, a loss rate of power at the exchange time between the output and input at both ends of each stroke is a question remains to be answered. Overall speaking, the energy efficiency of the reciprocating piston engine is given in literatures. Energy is consumed and wasted for generating heat. For example, the energy efficiency of gas is only 29% and the energy efficiency of diesel is only 34%. Over 60% of energy is wasted from the heat consumption. According to a report given by Chung Shan Scientific Research Institute of Taiwan, the efficiency of gasoline is 25% only. With a profound exploration, the efficiency can be enhanced up to over 50% after improvements are made, and it is an objective of the present invention to overcome the shortcoming of the prior art. The ignition for the traditional engine has a high requirement for the airtightness, and thus the clearance between the cylinder and the piston is maintained below 0.05 m.m. For any over-heat or slight leakage of gas pressure, the compression ratio may be reduced, such that the engine cannot be started. If the explosion is too large, a heavy and durable structural body is required. To cope with the thermal expansion and maintain the temperature required for a spontaneous ignition of petroleum at 300° C., the cylinder must be water cooled, wherein the temperature of a water tank is controlled at approximately 100° C. The low-temperature combustion has a low efficiency and a poor acceleration function. Let us imagine how the quantity of fuel should be added if it is necessary to add fuel once every two rotations. On the other hand, the rotary engine has the advantages of a quick response and a good acceleration function.

### SUMMARY OF THE INVENTION

Therefore, it is a primary objective of the present invention to overcome the shortcomings of the prior art by providing a rotary engine to improve the pressure difference produced by excluding the waste gases, the limitation of providing a direct impact force of a high-pressure air flow, the difficulty of improving the transient action force due to a constant volume, and the limited power output.

To achieve the foregoing objective, the present invention provides a rotary engine comprising a least one set of combustion chambers installed around a turbine, wherein the combustion chamber includes a movable plate installed at an opening which is formed at a front end of the combustion chamber for pushing and rotating an external periphery of the turbine which is rotated and erected at an angle of 90 degrees, and both sides of the movable plate are aligned linear to the diameter of the turbine to form an approximately straight line, and the combustion chamber further includes at least one slide member installed at an external periphery of the turbine, and a U-shape groove formed at an end of an internal arc surface of the slide member, and an end of the groove is an open end coupled tightly to the movable plate to form the explosion chamber.

To achieve the foregoing objective, the invention provides a rotary engine comprising the following elements:

An arc casing is installed on a side of a frame and comprised of an arc guide rod, a stop screw, two sets of slide member positioning devices and a plurality of adjusting screws for supporting the slide members, and all of the aforementioned components are installed at a front end of an arc surface of the arc casing.

A main shaft is passed through the center of the turbine in the frame, and at least one set of combustion chambers are installed along an external periphery of the turbine, and a movable plate is installed at a front end of an opening of the combustion chamber, and a central shaft support device is installed on the turbine, and the movable plate and the U-shape groove formed on the internal arc surface of the slide member constitute the explosion chamber, and the movable plate is provided for pushing the turbine to rotate.

A slide member is movably installed in the arc casing and suspensively fixed to the external periphery of the turbine, such that the internal arc surface of the slide member and the external periphery of the turbine are airtight, and the U-shape groove is formed on the internal arc surface of the slide member, and an end of the U-shape groove is open for providing an explosion space, and two or more inwardly concave oblique cones, two V-shape grooves and a gas inlet are formed on an external arc surface of the slide member, wherein the inwardly concave oblique cone correspond to the adjusting screw on the arc casing, and the V-shape groove corresponds to the position fixing device of the arc casing, and the gas inlet can supply a mixed fuel to the combustion chamber only.

Both ends of the explosion chamber are comprised of different components, and an end is fixed at a front end in the U-shape groove formed at an end of the internal arc surface of the slide member, and another end is supported by the movable plate and the central shaft, and both ends of the central shaft are installed at the front end of the opening of the combustion chamber by a shaft sleeve, and the movable plate is protruded from the external periphery of the turbine and disposed opposite to the fixing end.

A ditch is formed at a front end of an internal arc surface of the slide member, and an inverted corner is formed separately on both edges of the internal arc surface, and the circular arc plate and the arc press strip held by the pressure of the spring maintain the airtightness between the slide member and the turbine.

The V-shape groove position fixing device includes a square sleeve formed on an internal side of the arc casing, a screw thread formed on an external side of the arc casing, and a square bar installed at the center of the square sleeve, wherein a V-shape body is disposed at a front end of the square bar, and a spring and a screw are installed at a rear end of the square bar for adjusting an external force applied for fixing onto the V-shape groove.

The movable plate is movable and capable of rotating 90 degrees clockwise, such that the movable plate is protruded from the external periphery of the turbine to create the space for gases expansion, or rotating 90 degrees counterclockwise, such that the movable plate is retracted and hidden into the combustion chamber to facilitate a later operation.

A movable plate ring is embedded into an external periphery of the movable plate, and an oblique surface is formed at a front end of the movable plate ring to facilitate coupling the U-shape groove and enhancing the airtightness of the explosion chamber.

Compared with the prior art, the present invention has the following advantages:

1. The present invention includes the processes of intake, ignition, explosion and exhaustion of gases integrated into a single stroke, and carried out at different positions simultaneously. Profound studies show that the mixed gas in injected into the combustion chamber by the pressure of the mixed gas automatically, so that it does not require any control or unique process except the control of the operating flow, and the ignition is synchronous, and the explosion and exhaustion occurs on both sides of the movable plate simultaneously. As a result, when the turbine rotates a round, the number of combustion chambers built at the periphery of the turbine is equal to the number of explosions, and an increased number of explosions can reduce the explosion capacity for each time, so as to reduce the weight of the structure and improve the acceleration performance for an effective acceleration. On the other hand, the traditional engine adds fuels once per every two rounds, and thus the increased energy is very limited. If it is necessary to increase the torque, more slide members are added to increase the driving force. The aforementioned combustion chamber is not limited to any particular shape, but preferred to have a wide and shallow opening, so that the combustion chamber has quick thermal expansion and exhaustion of the high-pressure gases. The larger the pressure difference, the larger is the driving force. In the principle of lever, the larger the radius of the turbine, the more is the effort saving. In other words, a low pressure can be effective for an explosion, and the explosion must be conducted in a sealed space. In addition, the thermal exchanger can be used for recycling the heat contained in the waste gases and heating an intake air, or producing steam as the kinetic energy for the engine again after the temperature of the cooling water rises.

2. The present invention uses the inwardly concave oblique cones and adjusting screws to replace the current existing roller to support the slide member. The invention is without more precise, but it can be durable, and it is also easier to fine tune to reduce the error of the clearance. During the explosion, the explosive force can drive the turbine to rotate clockwise, and the reaction force can drive the slide member to rotate counterclockwise. If the reaction force is too large, the lateral component force will be increase to produce a resistance to the operation, so that a stop screw installed at the front end of the slide member can improve the aforementioned shortcoming and also can adjust the clearance and tightness between the slide member and the turbine. An included angle θ is defined between the tangents of the joint surface of the inwardly concave oblique cone and the adjusting screw and the joint surface of the slide member and the turbine, and the pressure between the slide member and the turbine is expected to be approaching to zero to reduce the frictional resistance and the loss of dynamic power, and the pressure is inversely proportional to the included angle θ, and thus it is necessary to select an appropriate included angle θ.

3. The present invention includes the circular arc plate and the arc press strip installed at the joint of the turbine and the slide member, such that when the slide member is covered around the external periphery of the turbine, three edges except the exhaust end are airtight and situated on both sides of the arc press strip, and the spring is held against and attached closely to the edges of the two joint surfaces of the turbine, and the circular arc plate is embedded into the internal arc surface of the slide member. Similarly, the spring is abutted against and attached closely to the arc surface of the turbine, and an oblique surface is formed at the bottom proximate to the internal side of the circular arc plate can improve the airtight effect. Theoretically, the turbine and the slide member of the present invention are sealed concentrically, but practically, the arc press strip and the circular arc plate require the compression of a spring to assure the airtight effect, since they may be deformed easily by thermal contraction, expansion or worn-out.

### BRIEF DESCRIPTION OF THE DRAWINGS

FIG. 1 is an exploded view of a preferred embodiment of the present invention;

FIG. 2 is an exploded view of a turbine and a movable plate in accordance with the present invention;

FIG. 3 is a schematic view of a movable plate pushing a turbine to rotate in accordance with the present invention;

FIG. 4 is a perspective view of a preferred embodiment of the present invention;

FIG. 5 is a cross-sectional view of an assembly in accordance with a preferred embodiment of the present invention; and

FIG. 6 is a schematic diagram of vectors produced during an explosion in accordance with a preferred embodiment of the present invention.

### DETAILED DESCRIPTION OF THE PREFERRED EMBODIMENTS

The structural assembly, overall operation and technical characteristics of the present invention will become apparent with the detailed description of a preferred embodiment and the illustration of the related drawings as follows.

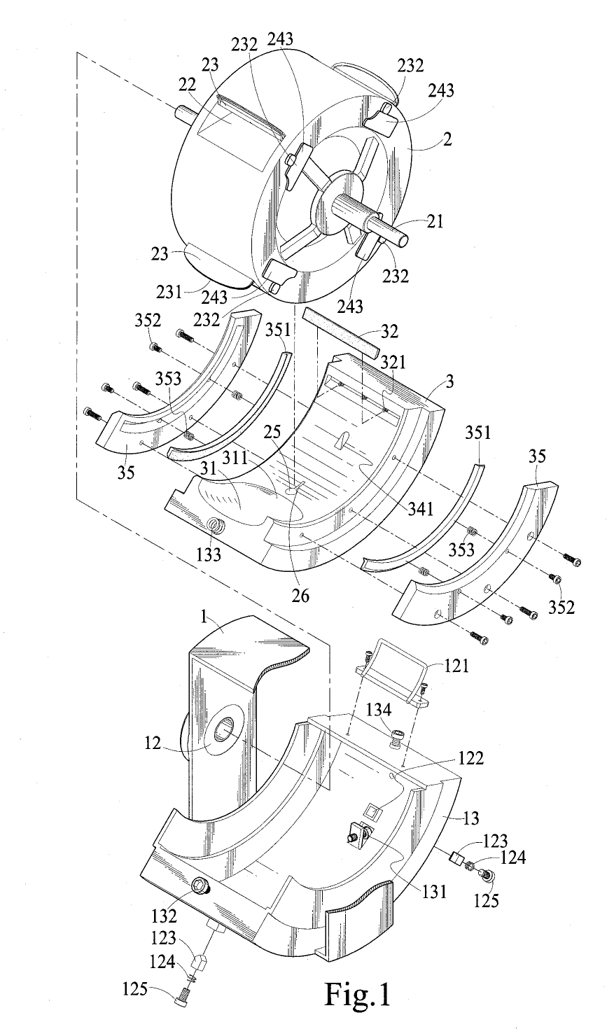

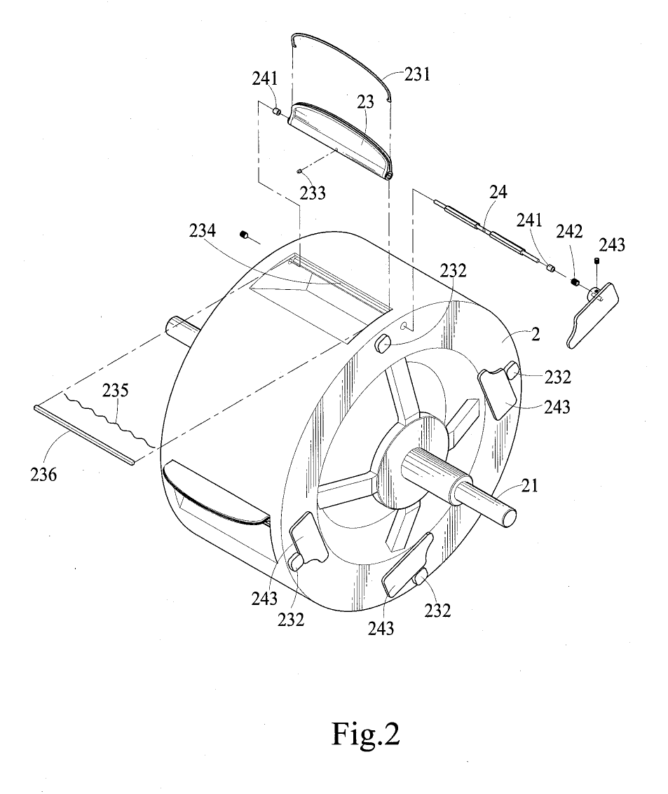

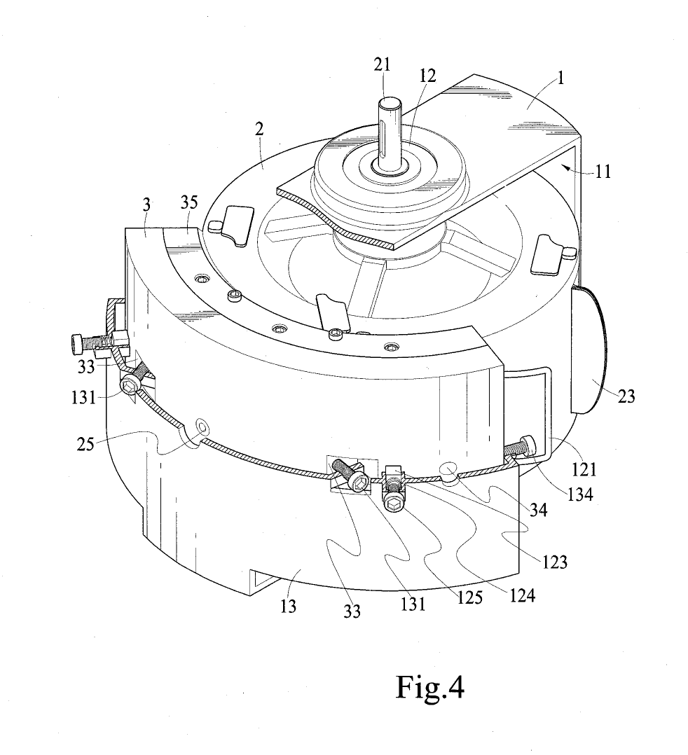

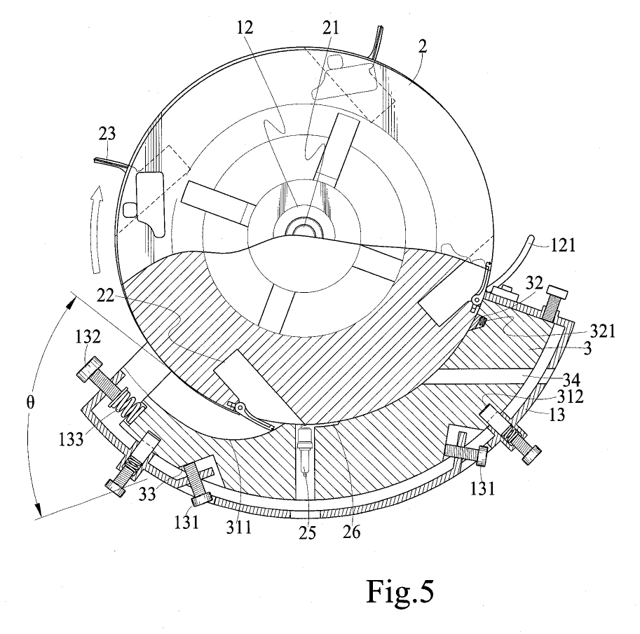

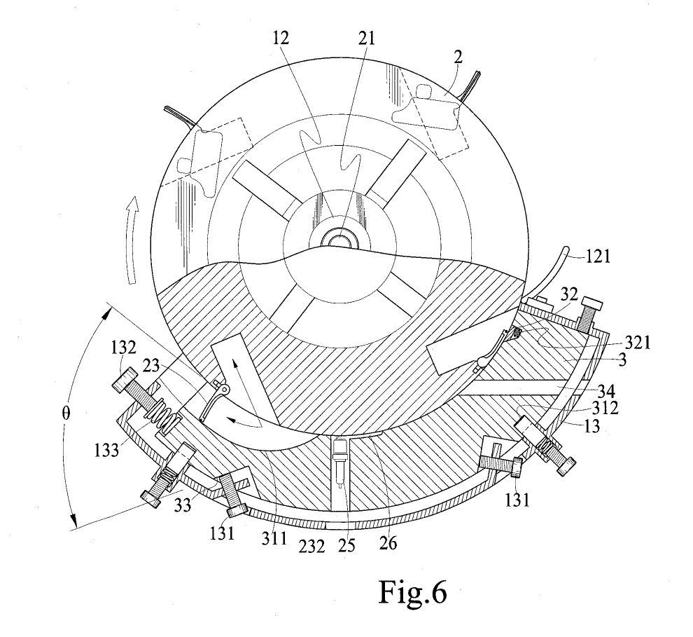

With reference to FIGS. 1 to 6, the structure of the engine of the present invention eliminates the compression stroke among the four strokes, so that the fuel, the mixed gas, and high-pressure air are supplied from the outside, or an air compressor with appropriate power is used for this engine. Firstly, it is necessary to start a motor to rotate a turbine 2 (not shown in the figure), and then a main shaft 21 directly transmits a compressor, and an evaporator or a carburetor mixes and a fuel with a low ignition point such as liquefied petroleum gas and petroleum with air, and a gas inlet of the compressor sucks in the fuel for performing a compression to produce an output with a rising temperature introduced into a gas inlet 34 of the engine, and the pressure of the mixed gas is provided for injecting the mixed gas into a combustion chamber 22, and a groove 341 formed on an internal side of the gas inlet 34 can extend the intake time, and a passage 26 is provided for igniting the mixed gas in advance and improve the chance of the ignition. Before the combustion chamber 22 is turned into the position of the circular arc shape 311, the spark plug is used directly for the explosion to push the movable plate 23 to be erected and protruded from the external periphery of the turbine and the U-shape groove 31 to form the explosion chamber, whose internal high-temperature mixed gas produces an explosion to drive the movable plate 23 to rotate, and a roller 135 is used as a fulcrum, and a lever 243 is provided for driving the turbine 2 to rotate forward, and the movable plate 23 discharges all waste gases in the U-shape groove 31 to the outside. The movable plate 23 is turned back repeatedly, and an arc guide rod 121 guides the movable plate 23 to rotate 90 degrees counterclockwise to a position aligned evenly with external periphery of the turbine 2, and the movable plate 23 is hidden at an open end of the combustion chamber 22 before the gas intake takes place. For the engine of the present invention, the intake and exhaust do not take much effort, and the compression stroke is separated to provide a high efficiency. However, the explosion stroke requires further studies. The intake does not take much effort, and the exhaust does not have much resistance, and the compression is efficient, and the explosion is powerful, and a driving force is produced simultaneously at the bottom of the combustion chamber 22 and the back of the movable plate 23, the movable plate 23 is a circular arc shape by its side view.

With reference to FIGS. 1 to 6 for the main structure of a rotary engine of the present invention, the rotary engine comprises the following components:

A surrounding frame 1 includes a containing space 11 formed at the middle of the frame 1, a bearing 12 installed at the middle of horizontal sections on both sides of the frame 1, an arc casing 13 installed at a vertical section of the frame 1, an arc guide rod 121 and a stop screw 134 installed at a front end of the arc casing 13, a plurality of adjusting screws 131 installed onto the arc surface, a set of position fixing device (including a square sleeve 122, square bar 123, spring 124, adjusting screw 125) installed at the middle of both ends of the arc surface respectively, and an adjusting screw 132 and spring 133 installed at the end (such as the exhaust edge) of the arc casing 13.

A turbine 2 includes a main shaft 21 penetrating through the center of the turbine 2, and movably passing between two bearings 12 of the frame 1, a plurality of combustion chambers 22 disposed on an external periphery of the turbine 2, wherein each combustion chamber 22 has a movable plate 23 installed at an opening at the front end of the combustion chamber 22, a central shaft 24 penetrated through an end of a lateral side of the movable plate 23, and both ends of the central shaft 24 being supported on the turbine 2 by a shaft sleeve 241, a movable plate ring 231 embedded into a portion of the turbine 2 protruded from the lateral side of the movable plate 23 for enhancing the airtightness of the U-shape groove 31, a ditch 234 formed at a front end of the opening of the combustion chamber 22 for facilitating embedding a spring wire 235 and a slide plate 236 to enhance the airtightness between the combustion chamber 22 and the movable plate 23. During an explosion, the movable plate 23 is turned 90 degrees clockwise along the rotating direction of the turbine 2, and a stop plate 232 installed on an external or internal side of the combustion chamber 22 is provided for controlling its angle and position. After the movable plate 23 is pushed away from the U-shape groove 31, the driving force is eliminated, and the arc guide rod 121 guides the movable plate 23 to be fixed into a position, and then another intake stroke takes place. During installation, the spring is compressed to attach the arc press strip 351 closely with the edge of the two joint surfaces of the turbine 2, such that both sides of the slide member 3 are airtight.

A slide member 3 is movably installed in the arc casing 13, such that the slide member 3 is covered onto an arc surface of the turbine 2, and a circular arc plate 32 is formed on an internal arc surface of the slide member 3 and embedded in a concave cavity, and a spring 321 is used for applying a force to maintain the airtight effect at the arc surface of the turbine 2, and then a groove 341 is formed on an internal side of a gas inlet 34 for extending an intake time, and a passage 26 is provided for introducing a mixed gas for performing an ignition at an earlier time and a hidden spark plug 25 is provided for continuing the ignition, and then a circular arc shape 311 for coupling the U-shape groove 31 to an open end and the movable plate 23 constitute an explosion chamber. During explosion, the movable plate 23 drives the turbine 2 to rotate, while exhausting the waste gas, and two V-shape grooves 312, two inwardly concave oblique cones 33 and a gas inlet 34 are formed on an external arc surface of the slide member 3, and the V-shape groove 312 is fixed at a position opposite to the V-shape body at the front end of the square bar 123 of the arc casing 13, and the inwardly concave oblique cone 33 is disposed opposite to the adjusting screw 131 of the arc casing 13, and the gas inlet 34 is provided for supplying gas to the combustion chamber 22 only. In addition, a support component 35 is installed separately on both lateral sides of the slide member 3, and the support component 35 contains an arc press strip 351, and a plurality of screws 352 and springs 353 installed on a side of the arc press strip 351. During installation, the two inwardly concave oblique cones 33 on the arc casing 13 must be coupled tightly with the adjusting screws 131, and the adjusting screw 132 is provided for adjusting and applying an appropriate compression to the spring 133 at an exhaust end by controlling the compression between the slide member 3 and the turbine 2. In the meantime, the turbine 2 plus three adjusting screws 131, 132 are used for clamping the slide member 3 to be suspended on an arc surface of the turbine 2, such that the slide member 3 remains almost fixed except a slight movement caused by thermal expansion. With the installation of the stop screw 134, a relatively large reaction force can be withheld without increasing the pressure between the turbine 2 and the slide member 3. However, an adjustment of the stop screw 134 can change the clearance and tightness between the turbine 2 and the slide member 3.

The present invention has the following features and advantages:

1. The present invention includes the intake, ignition, explosion and exhaust strokes integrated into a single stroke, and carried out at different positions. Through careful studies, the mixed gas is injected into the combustion chamber 22 by the pressure of its own, such that no control or unique process is required except the control of the operating flow, and the ignition is also synchronous, and the explosion and the exhaust occurred on both sides of the movable plate 23 at the same time. Therefore, when the turbine 2 rotates one round, the number of combustion chambers 22 will be equal to the number of explosions, number of explosions, such that the level of each explosion can be lowered, and the weight of the structure can be reduced to enhance acceleration and performance. A quick acceleration can be achieved. On the other hand, fuel is added once for every two rounds made by the traditional engine, so that the increased power is very limited. If it is necessary to improve the torque, more slide members 3 can be added to increase the driving force. The aforementioned combustion chambers 22 are not limited to any particular shape, and it preferably comes with a wide opening and a shallow body, so that the high-pressure gas can be expanded, reacted and discharged quickly. The larger the pressure difference, the larger is the driving force. According to the principle of lever, the larger is the radius of the turbine 2, the better is the labor-saving effect. In other words, low gases pressure can be run. The explosion must be held in a sealed airtight space. In addition, a thermal exchanger is provided for recycling the heat contained in the waste gases and providing the heat for the intake stroke, or the cooling water is heated to form vapor after the temperature rises, so as to supply kinetic energy for the engine.

2. The present invention uses the inwardly concave oblique cone 33 and adjusting screw 131 to replace the prior roller to support the slide member. Such arrangement not only provides a more precise and durable application, but also provides an easier way for fine tuning to reduce the tolerance. During the explosion, the explosive force can drive the turbine 2 to rotate clockwise, and the reaction force drives the slide member 3 to rotate counterclockwise. If the reaction force is too large, the lateral component force is increased to produce a resistance to the operation, so that a stop screw 134 installed at the front end of the slide member 3 can overcome the foregoing shortcomings and also can adjust the clearance and tightness between the slide member 3 and the turbine 2. An included angle θ is defined between tangents of a joint surface of the foregoing inwardly concave oblique cone 33 and the adjusting screw 131 and a joint surface of the slide member 3 and the turbine 2, in hope of keeping the compression between the slide member 3 and the turbine 2 to be approaching to zero, so as to reduce frictional resistance and loss of dynamic power, and the compression is inversely proportional to the included angle θ. Therefore, it is necessary to select an appropriate included angle θ.

3. The present invention includes the circular arc plate 32 and the arc press strip 351 disposed at the joint of the turbine 2 and the slide member 3, such that when the slide member 3 is covered onto the external periphery of the turbine 2, three sides (except the exhaust end) are airtight, and the arc press strip 351 is separately disposed on both sides, so that the spring 353 can be compressed to attach the edges of the two joint surfaces of the turbine 2, and the circular arc plate 32 is embedded into the internal arc surface of the slide member 3. Similarly, the spring 321 is compressed to attach the arc surface of the turbine 2. In addition, the circular arc plate 32 includes an oblique surface formed at the bottom of an internal side of the circular arc plate 32 to enhance the airtight effect. Theoretically, the turbine 2 and the slide member 3 of the present invention are attached concentrically, but in actual operations, thermal expansion and worn-out will produce a deformation, so that the compression of the springs 353, 321 must be used to assure the airtight effect between the arc press strip 351 and the circular arc plate.

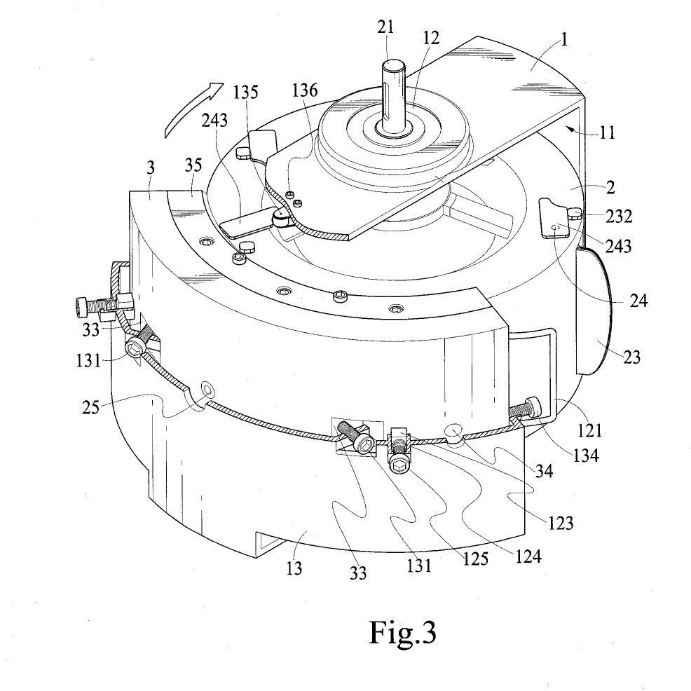

The present invention provides a rotary engine explosion chamber, such that an open space can be extended during an explosion, and both ends of the explosion chamber are comprised of two sets of different components and installed opposite to each other, and the distance between the two sets can be moved to increase the space, and a fixed end of the U-shape groove 31 fixed to an end of the internal arc surface of the slide member 3 is in a circular arc shape 311, and the end of the U-shape groove 31 is an open end, and another end of the U-shape groove 31 includes a movable plate 23 installed at a front end of an opening of the combustion chamber 22 on the turbine 2, and supported by a central shaft 24, and both ends of the central shaft 24 are installed and fixed onto the turbine 2 by a shaft sleeve 241, and the movable plate 23 protruded from the external periphery of the turbine 2 is used for replacing the piston and the fixed end of a traditional engine. As the turbine 2 rotates, the U-shape groove 31 formed on the internal arc surface of the slide member 3 constitutes the explosion chamber. During explosion, a driving force is produced to increase the distance from the fixed end, and forces are exerted onto the movable plate 23 and the bottom of the combustion chamber 22, so that a high-pressure gas can obtain an expansion space, and a torque is produced for rotating the turbine 2. During explosion, a precise cooperation between the U-shape groove 31 and the movable plate 23 must be maintained, or else the production of forces will be affected, and noises and worn-outs will result, or the operation will be failed. The fixed end in the U-shape groove 31 is in a circular arc shape, and the movable plate 23 is erected along the arc surface to bear the explosion and rotate 90 degrees. Generally, a relatively large impact force will be produced, and an oblique surface formed at the front end remains fixed, and an oblique surface is also formed at a front end of the movable plate ring 231, and the body is elastic, and the centrifugal force of the rotation has a slight contraction function for compensating the insufficient airtightness between the two. In addition, an accessory measure is provided as shown in FIG. 3, wherein a central shaft is extended to the outside and a lever 243 is installed to link with the movable plate 23, and a roller 135 is fixed and installed at an appropriate position of the frame 1 to serve as a fulcrum. When the movable plate 23 rotates, the central shaft 24 drives the turbine 2 to rotate, and the turbine 2 and the movable plate 23 are operated synchronously. In a lower speed, a greater torque can be achieved. In addition, the turbine 2 can be fixed easily, but a suspension method should be taken into consideration for the slide member 3 in order to make appropriate adjustments automatically to cope with the compression and gap caused by thermal contraction and expansion. A precise position is required at the middle of both ends of the external arc surface of the slide member 3, so that a V-shape groove 312 is formed at the middle of both ends of the external arc surface for the positioning purpose. The opening of the U-shape groove 31 of the internal arc surface is slightly tilted outward and coupled closely with the movable plate 23 for providing an automatic positioning function. If the movable plate 23 compresses and latches the internal side of the U-shape groove 31, the turbine 2 will continue to rotate forward, and the movable plate 23 will be pulled backward to tilt and loosened immediately. When the movable plate 23 is erected, the lateral sides of the movable plate 23 and the diameter of the turbine 2 constitute an approximately straight line, and the rear side of the movable plate 23 is perpendicular to the air flow of the explosion to drive the turbine 2 to rotate, and the front side of the movable plate 23 will push the waste gas remained in the U-shape groove 31 to the outside. To maintain the balance and reduce the vibration of a high-speed rotating turbine 2, the slide member 3 is installed, preferably in pairs, and the number of combustion chambers 22 and the rotating radius of the turbine 2 are not restricted. The larger the diameter of the turbine 2, the more is the labor saving effect and the higher is the efficiency. The movable plate 23 rotated at a high speed is hindered by the resistance of the waste gas, and an arc guide rod is provided for guiding and driving the movable plate 23 to rotate 90 degrees counterclockwise and return to its fixed position, such that the movable plate 23 and the external periphery of the turbine 2 are returned to positions in front of the gas inlet 34. Since the movable plate 23 has a height smaller than the length of the opening of the combustion chamber 22, a groove 341 is formed on an internal side of the gas inlet 34 of the slide member 3 to provide the functions of extending the intake time and making the intake easier. After the combustion chamber 22 is moved to the explosion chamber, the indentation of the lever 243 has been pass through the roller 135 in a while, the mixed gas is ignited and exploded to push the movable plate 23 to slide into an oblique surface which is in front of the U-shape groove 31, to serve as a buffer and reduce the impact between the lever 243 and the roller 135 when they are make contact with each other, the movable plate 23 is turned by 90 degrees clockwise and erect, such that the movable plate 23 and the U-shape groove 31 on the slide member 3 constitute the explosion chamber. Since heat is accumulated during the continuous explosions occurred in the explosion chamber, the temperature will exceed 500□, thus the gas fuel will be ignited and exploded automatically or an electronic ignition device installed in the explosion chamber can be used for igniting the gas for the continuous explosions, therefore, no time difference or delay will happen when the explosion occurred. Thus the compression ratio need not be too precisely. Even if the airtightness is poor, the explosion will occur (with a weaker power). To achieve a better airtightness, the movable plate ring 231 installed around the external periphery of the movable plate 23 can enhance the airtight effect. In the position fixing device of the V-shape groove 312 as described above, the square sleeve 122 is installed at the arc casing, a square bar 123 is installed at the center of the square sleeve 122 and the front end of the square bar 123 has the V-shape body, and the rear end of the square bar is compressed by the spring 124 and the adjusting screw 125 and fixed onto the V-shape groove 312. The present invention is characterized in that the movable plate 23 is turned 90 degrees clockwise during an explosion to create an expansion space for the high-pressure gases. Before the intake, the arc guide rod guides the movable plate 23 to turn 90 degrees counterclockwise and return to its original position. On the contrary, it pushes the movable plate 23 to return by an air flow and in due course. The slide member 3 supports the inwardly concave oblique cone 33 by the adjusting screw 131, and the spring 353 and the adjusting screw 131 at the rear side are provided for clamping and suspending it at the external periphery of the turbine 2. Although an appropriate angle θ can maintain the compression between the turbine 2 and the slide member 3 to be approaching to zero, the action force produced in a dynamic situation of an explosion will drive the movable plate 23 to rotate clockwise, and the reaction force will drive the slide member 2 to rotate counterclockwise. Even though there are inwardly concave oblique cone 33 and adjusting screw 131, the reaction force still affects the compression between the slide member 3 and the turbine 2. Therefore, it is necessary to install a stop screw 134 at the front end of the slide member 2 to vertically and effectively block the reaction force and adjust the clearance between the turbine 2 and the slide member 3 to reduce resistance.

While the invention has been described by means of specific embodiments, numerous modifications and variations could be made thereto by those ordinarily skilled in the art without departing from the scope and spirit of the invention set forth in the claims.

What is claimed is:

1. A rotary engine, characterized in that a turbine comprises: one or more combustion chambers disposed around the turbine; a movable plate installed at a front end of an opening of the combustion chamber and rotated 90 degrees to an erect position protruded from an external periphery of the turbine, and both sides of the movable plate and the diameter of the turbine forming an approximate straight line; at least one slide member installed at the external periphery of the turbine; a U-shape groove formed at an end of an internal arc surface of the slide member, and having an open end coupled closely with the movable plate to constitute an explosion chamber.

2. A rotary engine, comprising:
an arc casing, installed on a side of a frame, and having an arc guide rod, a stop screw, disposed at a front end of the arc casting, two sets of slide member position fixing devices and a plurality of adjusting screws for supporting the slide member, a turbine, installed in the frame, and having a main shaft penetrated through the center of the turbine, at least one set of combustion chambers disposed along an external periphery of the turbine, a movable plate installed at a front end of an opening of the combustion chamber, and supported by a central shaft installed on the turbine, such that the movable plate and a U-shape groove formed at an end of an internal arc surface of the slide member constitute an explosion chamber, and the movable plate being provided for driving the turbine to rotate;
the slide member movably installed in the arc casing and suspensively fixed to the external periphery of the turbine, such that the internal arc surface of the slide member and the external periphery of the turbine are airtight, and the U-shape groove being formed on the internal arc surface of the slide member, and the U-shape groove having an open end for providing an explosion space, and two or more inwardly concave oblique cones, two V-shape grooves and a gas inlet are formed on an external arc surface of the slide member, and the inwardly concave oblique cone corresponding to an adjusting screw on the arc casing, and the V-shape groove corresponding to the position fixing device on the arc casing, and the gas inlet being provided for supplying a mixed fuel gas to the combustion chamber only.

3. The rotary engine according to claim 2, wherein both ends of the explosion chamber are comprised of different components, and an end of the explosion chamber is fixed to a front end of the U-shape groove formed at an end of the of the internal arc surface of the slide member end, and another end of the explosion chamber is supported by a central shaft from the movable plate, and both ends of the central shaft are fixed at a front end of an opening of the combustion chamber by a shaft sleeve, and the movable plate is protruded from the external periphery of the turbine and disposed opposite to a fixed end.

4. The rotary engine according to claim 2, wherein the slide member includes a ditch formed at a front end of an internal arc surface of the slide member, and an inverted cone is formed separately on both edges of the internal arc surface, and a circular arc plate and an arc press strip are used for maintaining the airtightness between the slide member and the turbine by a spring pressure.

5. The rotary engine according to claim 2, wherein a V-shape groove positioning device includes a square sleeve disposed on an internal side of the arc casing, a screw thread formed on an external side of the arc casing, a square bar installed at the center of the square sleeve, a V-shape body formed at a front end of the square bar, and a spring and a screw are installed at a rear end of the square bar for adjusting an external force applied for fixing onto the V-shape groove.

6. The rotary engine according to claim 3, wherein the movable plate is movable and capable of turning 90 degrees clockwise and being protruded from the external periphery of the turbine to create an air expansion space, or capable of turning 90 degrees counterclockwise to retract and hide in the combustion chamber for facilitating a following course.

7. The rotary engine according to claim 6, wherein the movable plate includes a movable plate ring embedded into an external periphery of the movable plate, and an oblique surface formed at a front end of the movable plate ring front end for facilitating coupling the U-shape groove and enhancing the airtightness of the explosion chamber.
